(19) United States
(12) Patent Application Publication
(10) Pub. No.: US 2007/0219966 A1
(43) Pub. Date: Sep. 20, 2007

(54) DIRECTORY HAVING MULTIPLE LISTING TYPES

(76) Inventors: Steve Baylis, Renton, WA (US); Kevin Fink, Carnation, WA (US); Alex Algard, Seattle, WA (US); Max Bardon, Seattle, WA (US); Rob Voce, Seattle, WA (US)

Correspondence Address: PERKINS COIE LLP;PATENT-SEA, P.O. BOX 1247, SEATTLE, WA, 98111-1247, US

(21) Appl. No.: 11/686,178

(22) Filed: Mar. 14, 2007

Related U.S. Application Data
(60) Provisional application No. 60/782,245, filed on Mar. 14, 2006.

(51) Int. Cl. G06F 17/30

(52) U.S. Cl. 707/3

(57) ABSTRACT

A directory system maintains one or more databases of user information. The directory system receives a query from a searching user to identify directory information for a target user. The directory system identifies matching listings from each database. The directory system merges the listings to create a user-friendly display listing that displays relevant information to the user without burdening the searching user with numerous duplicate listings. Then the directory system displays the display listing to the searching user.

### CROSS-REFERENCE TO RELATED APPLICATIONS

The present application claims priority to U.S. Provisional Patent Application No. 60/782,245 (Attorney Docket No. 341918001US), entitled “COMPUTERIZED DATA EXCHANGE SYSTEM, SUCH AS AN INTERNET-BASED SYSTEM FOR PROVIDING EMAIL EXCHANGE AND PRIVACY,” filed on Mar. 14, 2006, which is hereby incorporated by reference.

### BACKGROUND

A directory stores and organizes information about a network's users. For example, traditional telephone directories store lists of users organized by last name and first name that can be used to identify a particular user's telephone number. An online directory service generally utilizes a database to store large amounts of user information that is optimized for reads and provides advanced search possibilities on many different attributes that can be associated with objects in a directory. For example, an online directory may provide the ability to search for a user's phone number given the user's address or other information.

The Internet introduces many new ways of contacting users in addition to telephone numbers. For example, many Internet users now have an email address, web page, or a blog. A single provider in a particular geographic location traditionally handles telephone information. However, Internet users may use many different providers for different types of communication. For example, a particular user may have an email address provided by their Internet service provider (ISP), and another email address through a free web-based email service provider. The Internet also encourages anonymity, such that email providers do not typically publish directory listings that associate email addresses with a user's name, address, or other information.

Thus, identifying the best way to contact a particular Internet user can be difficult. Some services gather email addresses from many providers and provide basic lookup services. However, because email addresses are much more easily changed than traditional forms of communication such as telephone numbers, email information may be out of date or inaccurate. It is also common to find many email addresses for the same user. Some services charge a searching user for each email address that the searching user retrieves from the service. Users may be frustrated when they receive many listings for the same user, many of which are out of date.

There is a need for a system that overcomes the above problems, as well as one that provides additional benefits.

### BRIEF DESCRIPTION OF THE DRAWINGS

FIG. 1 is a block diagram that illustrates components of a directory system.

FIG. 2 is a flow diagram that illustrates the processing of a search component of the directory system.

FIG. 3 is a flow diagram that illustrates the processing of a merge listings component of the directory system.

FIGS. 4 and 5 illustrate displays produced by the directory system.

### DETAILED DESCRIPTION

The headings provided herein are for convenience only and do not necessarily affect the scope or meaning of the claimed invention.

Overview

A method and system for providing email and telephone listings is provided, sometimes referred to as the directory system. The directory system maintains one or more databases of user information. For example, a telephone database may contain first names, last names, telephone numbers, and street addresses for users, while an email database may contain email addresses, first names, and last names. The directory system receives a query from a searching user to identify directory information for a target user. The query may specify information such as the target user's first name, last name, and state of residence. The target user may be any individual, business, or other entity, and may not be a user themselves of the directory system. The directory system identifies matching listings from each database. For example, given the first name and last name of a target user, the directory system may identify matching listings in a telephone database and an email database. In addition, the directory system may find duplicate listings among the listings of any particular database. The directory system merges the listings to create a user-friendly display listing that displays relevant information to the user without burdening the searching user with numerous duplicate listings. For example, if there are several telephone listings for the target user, the directory system may only display the most recent listing. Then the directory system displays the display listing to the searching user. Thus, the directory system enables the searching user to more easily find relevant information about a target user.

Additional aspects of the system are described in further detail below. For example, the steps performed by the system to merge listings are described. In addition, the steps performed by the system to keep email listings up to date are described.

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

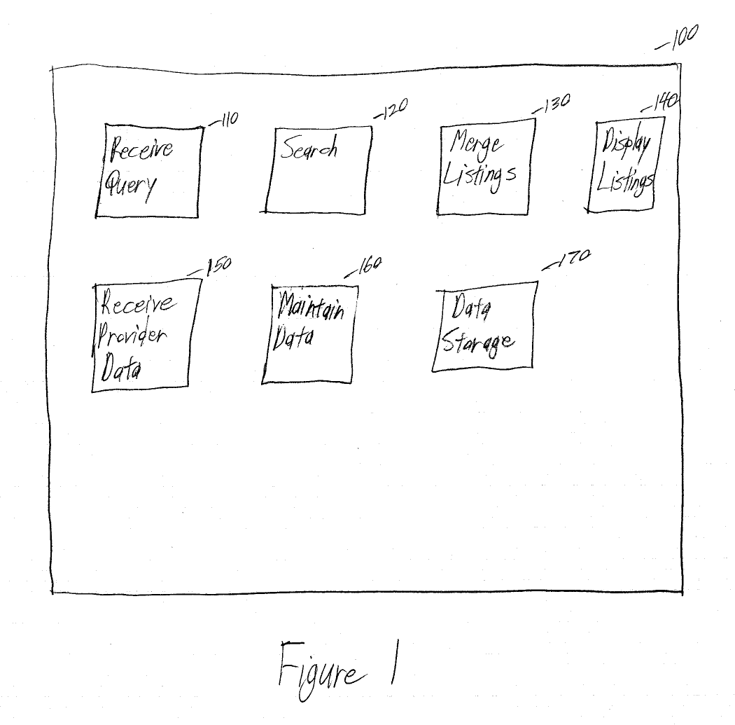

Unless described otherwise below, aspects of the invention may be practiced with conventional systems. Thus, the construction and operation of the various blocks shown in FIG. 1 may be of conventional design, and need not be described in further detail herein to make and use the invention, because those skilled in the relevant art will understand such blocks. One skilled in the relevant art can readily make any modifications necessary to the blocks in FIG. 1 (or other embodiments or figures) based on the detailed description provided herein.

FIG. 1 is a block diagram that illustrates components of the directory system, in one embodiment. The directory system 100 contains a receive query component 110, a search component 120, a merge listings component 130, a display listings component 140, a receive provider data component 150, a maintain data component 160, and a data storage component 170. The receive query component 110 receives a query from a searching user. The query may contain information that the searching user knows about a target user such as the target user's first name, last name, and state. The search component 120 identifies matching listings based on the information in the query. The search component may identify listings containing similar information such as nicknames, and may identify multiple matching listings. The merge listings component 130 combines similar listings into a single display listing, and combines listings of different types, such as telephone and email, that contain similar information. The display listings component 140 displays the merged listings to the searching user.

The receive provider data component 150 receives updated listings from various data providers. The component may receive data from a data provider periodically or may request new data from the data provider using an API provided by the data provider. The maintain data component 160 periodically examines the data provided by a data provider and validates the data as described herein. For example, the component may send a periodic email to the email address specified in each listing to determine if the email address is valid. The data storage component 170 stores listings in one or more databases maintained by the directory system. The component may include databases, file systems, storage area networks (SANs), and other common data storage facilities.

FIG. 1 and the discussion herein provide a brief, general description of a suitable computing environment in which the invention can be implemented. Although not required, aspects of the invention are described in the general context of computer-executable instructions, such as routines executed by a general-purpose computer, e.g., a server computer, wireless device, or personal computer. Those skilled in the relevant art will appreciate that the invention can be practiced with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer” are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. Aspects of the invention can also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

Merging Listings

In some embodiments, the directory system receives listings from multiple data providers. For example, a data provider may provide a database of email addresses for use with the system. The email addresses may have an associated name and street address. Email listings often do not have associated phone numbers. The data provider may provide the associated name as a single text string that is not split into first, middle, and last name. The directory system parses the name into its component parts and stores the component parts in a database managed by the directory system. The associated street address may be a residential or business address.

In some embodiments, the directory system receives listings from a data provider on a regular schedule. The directory system may receive the listings in bulk from the data provider at a specified time (e.g., weekly). Alternatively or additionally, the directory system may invoke an application programming interface (API) provided by the data provider to retrieve new listings on request. The directory system may pay the data provider a fee to receive the listings, as well as a fee per use of each listing. For example, the directory system may pay a fee to the data provider when a searching user retrieves a target user's email address.

In some embodiments, the directory system merges similar listings when a searching user searches the listings. In response to a search request, the directory system may search listings from multiple data providers in parallel. The directory system identifies similar information in the listings, such as the first name, last name, street address, and state. When two identified listings contain similar information, the directory system associates the two listings in the search results. For example, if the directory system identifies a telephone listing and an email listing for a target user having a same associated name and address, then the directory system associates the two listings in the search results.

In some embodiments, the directory system uses fuzzy matching to identify matching listings. For example, sometimes the name field of a listing contains two names, such as “Bob and Barbara Jones,” and the directory system may identify such a listing in response to a search for “Bob Jones.” The directory system may also match upon common nicknames. For example, a search for “Jim” may identify listings with an associated name “James.” Fuzzy matching makes the directory system more likely to find the listing that a searching user is trying to identify.

In some embodiments, the directory system maintains separate databases for data received from each data provider. For example, telephone listings may be stored separately from email listings, and listings within each of these categories may be stored separately based on the data provider from which the directory system received them. When the directory system receives a search request, the directory system may search each of the databases and merge similar listings in real time. Alternatively, the directory system may merge the listings before receiving a search request and create a merged database having data from many data providers.

In some embodiments, the directory system identifies the type of data. For example, the directory system may identify a telephone listing as residential, business, or government. When the directory system receives a search request, the request may identify a particular type of data to which to limit the search. For example, a searching user may want to identify the home contact information for a target user, and may limit the search to residential information. The directory system may use the type of data when merging listings from several data providers such that residential email listings are merged with residential telephone listings.

In some embodiments, the directory system provides several types of search that a searching user can request. For example, the directory system may provide a Find Person search, an Email Search, and a Reverse Phone Search. Each type of search locates different information about target users. For example, a Person Search may identify merged telephone and email listings for a target user. An Email Search may identify only email listings associated with a target user. A Reverse Phone Search may receive a phone number and identify the name of a target user with which the phone number is associated. In some embodiments, the searching user provides information in the search request about the type of information the user wants to receive. For example, the searching user may select a check box that indicates that email listings should be included in the search results.

In some embodiments, when the directory system receives a search request that includes email listings, the directory system may identify multiple matching email listings. If the directory system only identifies a single email listing, then the single email listing is associated with a display listing for display to the searching user. However, if the directory system identifies multiple matching email listings, then each of the listings are associated with a display listing for display to the searching user. The directory system may merge information from each of the listings together in the display listing. For example, when one email listing contains an associated name while another email listing contains an associated address, then the display listing may contain both the name and address.

In some embodiments, the directory system identifies matching email listings, but does not display email addresses to the searching user. The directory system may hide the email address and charge the searching user a fee to send email to the identified target user. When the directory system identifies multiple matching email listings, the directory system may display a single display listing to the searching user, but send email to each of the identified email addresses upon request. The directory system may charge the searching user for only one of the email addresses.

In some embodiments, the directory system selects one listing from among multiple matching listings to display to the searching user. The directory system may select a listing based on the price of the listing charged by the data provider from which the directory system received the listing. For example, the directory system may pay the data provider a royalty each time the directory system displays a listing to a searching user, and when multiple matching listings are found, the directory system may return the cheapest listing to the searching user. The directory system may also select a listing based on an associated last changed date that identifies how recent the listing data is. For example, the directory system may return the most recent listing when the directory system identifies multiple matching listings.

In some embodiments, the directory system does not display certain listing information to protect a target user's privacy. For example, when the directory system identifies a matching email listing but does not identify a matching public telephone listing, then the directory system may not display the street number associated with the email listing. Similarly, if the zip code contains a plus four (+4) extension in addition to a five-digit zip code, then the directory system may remove the plus four extension prior to displaying the listing.

In some embodiments, the directory system searches data providers based on the searching application. For example, the directory system may provide a general directory searching application that identifies data from all data providers (e.g., www.whitepages.com) and several targeted business-to-business search applications that identify a subset of the available listings. For example, the directory system may target one web site (e.g., www.phonenumber.com) for identifying matching phone numbers but not email addresses. The directory system maintains configuration data for each searching application, and, when a search request is received, searches the appropriate data providers based on the configuration information. The configuration data may also specify whether the directory system should merge listings from multiple data providers for a particular searching application.

In some embodiments, the directory system provides additional information with a display listing. For example, the directory system may retrieve additional information based on the geographic information in a listing, such as census information, the local time, and so forth. The directory system may display carrier information for telephone listings, such as the type of line (e.g., land) and the provider (e.g., Qwest). The directory system may also display advertisements targeted based on the information in the display listing.

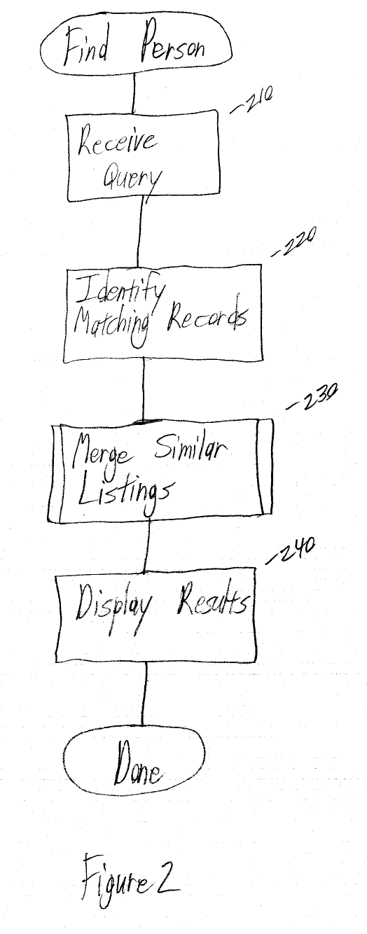

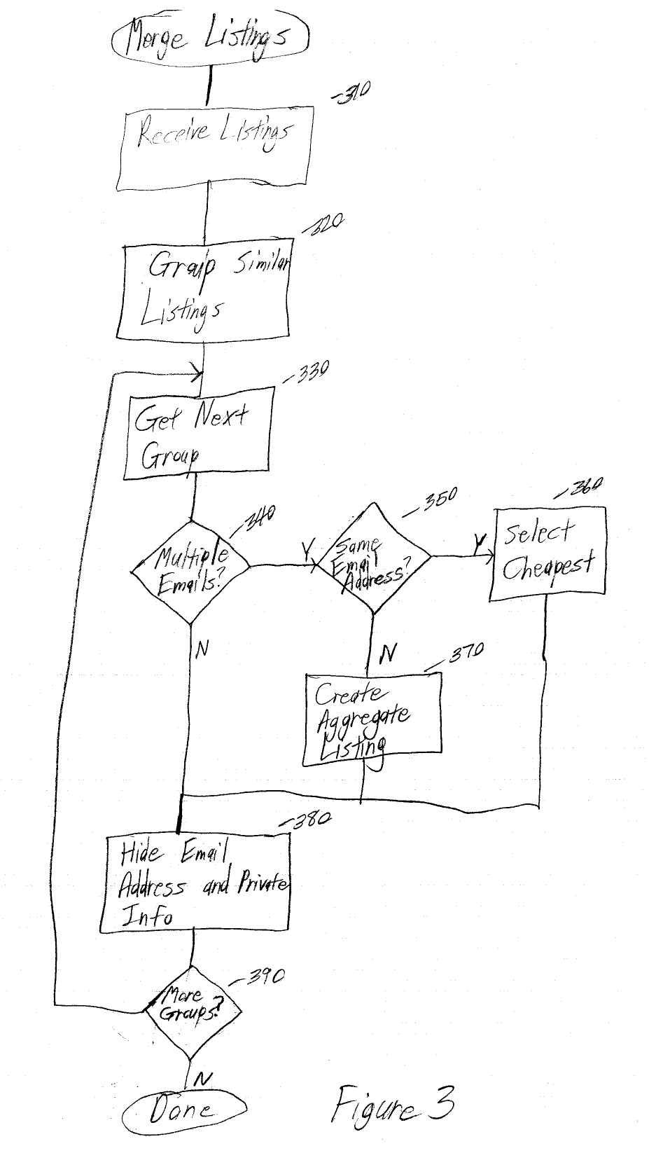

FIGS. 2 and 3 are representative flow diagrams that depict processes used in some embodiments. These flow diagrams do not show all functions or exchanges of data, but instead they provide an understanding of commands and data exchanged under the system. Those skilled in the relevant art will recognize that some functions or exchange of commands and data may be repeated, varied, omitted, or supplemented, and other (less important) aspects not shown may be readily implemented.

FIG. 2 is a flow diagram that illustrates the processing of the search component of the directory system in one embodiment. The component is invoked when a searching user submits a search request to find a target user. In step 210, the component receives a search query. The query may contain information that the searching user knows about the target user, such as the target user's name and address. In step 220, the component identifies matching records based on the received information. In step 230, the component merges similar listings into one or more display listings. For example, the directory system may merge listings having the same name and address, so that the searching user does not have to wade through numerous similar listings to find the information she is seeking. In step 240, the component displays the results to the searching user. After step 240, these steps conclude.

FIG. 3 is a flow diagram that illustrates the processing of the merge listings component of the directory system in one embodiment. In step 310, the component receives listings from one or more databases identified by the search component. In step 320, the component groups similar listings. For example, the component may group listings having the same name and address together. In step 330, the component selects the first group. In decision step 340, if the search identified multiple email listings, then the component continues at step 350, else the component continues at step 380. In step 350, if the multiple email listings contain the same email address, then the component continues at step 360, else the component continues at step 370. In step 360, the component selects the cheapest among the multiple similar email listings and continues at step 380. In step 370, the component creates an aggregate listing that associates the multiple email listings with a single display listing for display to the searching user and continues at step 380. In step 380, the component hides the email address(es) and any private information from the display listing so that it is not visible to the searching user. In decision step 390, if there are more groups, then the component loops to block 330 to select the next group, else the component completes.

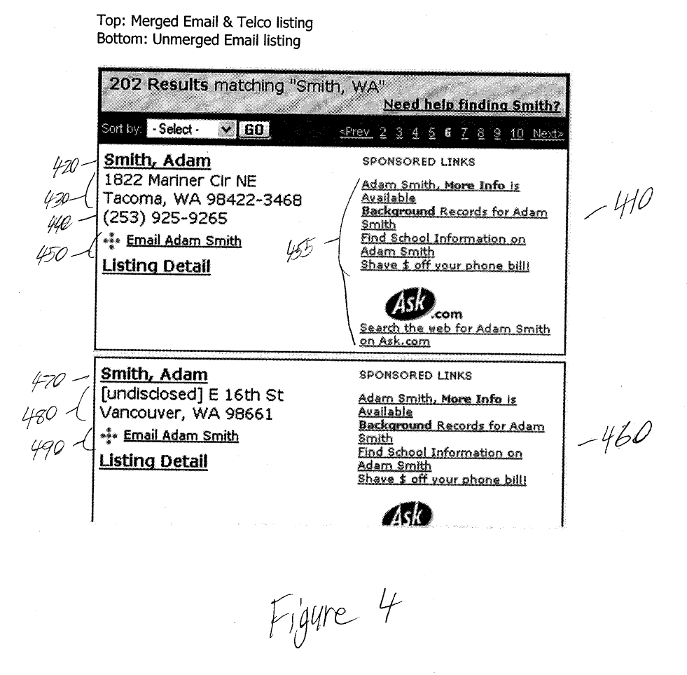

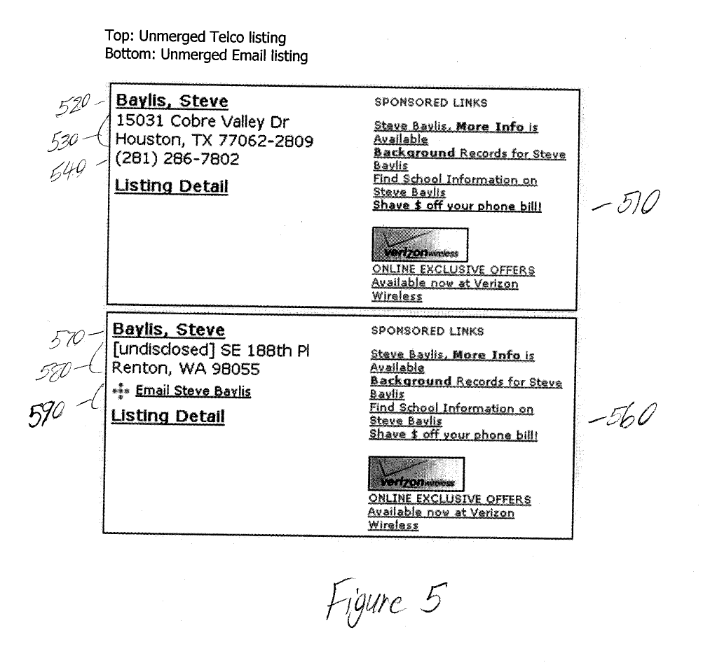

FIGS. 4 and 5 illustrate displays produced by the directory system in one embodiment. The top of FIG. 4 illustrates a merged email and telephone listing 410. The merged listing 410 contains a target user's name 420, street address 430, and telephone number 440. The merged listing 410 also contains a link 450, through which a searching user can request that the directory system send an email message to one or more email addresses that the directory system identified for the target user. The directory system may send the email through an email relay such that the searching user can send email to the target user but cannot view the target user's email address. The directory system may charge the searching user for sending the email message. The merged listing 410 also contains additional associated information 455, such as advertisements, related to the listing.

The bottom of FIG. 4 illustrates an unmerged email listing 460 for which the directory system did not identify an associated telephone listing. The unmerged listing 460 contains a target user's name 470, masked address 480, and a link to email the target user 490. To protect the target user's privacy, the directory system removes the street number for the listing because the directory system did not identify a public street listing. The email link 490, when selected, may cause the directory system to send email messages to multiple email addresses identified for the target user. The searching user is not burdened with a display of multiple listings containing similar information. Although the first listing 410 and second listing 460 may refer to the same user, the listings were not similar enough (e.g., different addresses) for the directory system to merge the two listings.

FIG. 5 illustrates an unmerged telephone listing and an unmerged email listing. The unmerged telephone listing 510, is similar to the listings in FIG. 4, but does not contain an option to email the target user, because the directory system did not identify a matching email listing. The unmerged listing 510 contains the target user's name 520, street address 530, and telephone number 540. The unmerged email listing 560 contains the target user's name 570, masked street address 580, and a link 590 to email the target user. The street number is masked to protect the target user's privacy because the directory system did not identify a matching public telephone.

Maintaining Email Listings

Maintaining the quality of listings perceived by searching users is important, particularly when the directory system charges searching users for either viewing or contacting target users through the listings. For email listings, it is important to keep the rate of receiving bounced emails low to make customers happier. An email system generally sends a bounced email message when an attempt is made to send email to an unknown email address. Users may change their email addresses frequently, such that an email address that is valid one day may not be valid a month later.

In some embodiments, the directory system assigns quality points to each listing in a listing database. The directory system assigns an initial points value and modifies the points assigned to a listing based on several quality checks. For example, directory system may examine the name associated with a listing and assign points based on the name. If the name contains offensive words, the directory system deducts points from the listing. Similarly, if the name contains certain fanciful words (e.g., Mickey Mouse), then the directory system deducts points from the listing. If the name contains certain invalid characters (e.g., ampersand, parenthesis, escaped HyperText Markup Language (HTML)), then the directory system may deduct points. Likewise, if the name does not contain any vowels or if the name contains an email address within it, the directory system may deduct points.

In some embodiments, the directory system assigns points based on the street address associated with each listing. For example, some zip codes are known to be invalid zip codes, and the directory system may reduce the points for a listing containing an invalid zip code. Some companies are large enough that they have an entire zip code assigned to them, and it is possible to verify that listings specifying those zip codes are from users at those companies. For example, many users commonly provide 12345 as a zip code when they do not want to provide their real zip code. However, the zip code 12345 is entirely assigned to a General Electric (GE) facility in Schenectady, N.Y., so the directory system may deduct points for users claiming this zip code that are not associated with GE.

In some embodiments, the directory system modifies the points assigned to a listing based on the domain of the email address in the listing. The domain of a known corporation (e.g., Microsoft.com) may receive extra points, whereas the domain of a free email service provider (e.g., Hotmail.com) may receive fewer points. Free email providers are known for producing high turnover among email addresses, such that email addresses at these domains can be considered less reliable.

In some embodiments, the directory system modifies the points assigned to a listing based upon the manner in which the listing was received. Sometimes contests are established to gather email addresses. For example, a contest may provide for giving away a free iPod to users that sign up with a particular service. Email addresses received in this manner may receive low points since many users will not provide their true email address in response to such a request. In contrast, an email address received from a corporation's employee list may receive high points since such addresses are highly reliable. Likewise, a paid ISP (e.g., aol.com) may receive higher points than a free ISP (e.g., gmail.com). The directory system may consider email addresses that contain words similar to their domain (e.g., bobjones@bobjones.com) to be personal domains that are generally reliable and assign additional points to the listings containing these email addresses. If a searching user of the directory system has previously emailed a target user through a listing, then the directory system may increase the points for that listing. Similarly, if the target user read the email, then the directory system may add additional points. If the email listing is also found in another database or product of the directory system, then the directory system may add additional points to the listing.

In some embodiments, the directory system periodically sends a test email message to the email address associated with each email listing. Based on the response to the test email, the directory system modifies the points of the listing. For example, if the email message bounces, then the directory system may deduct points or remove the listing entirely. Bounces may be distinguished between hard bounces (e.g., the user does not exist) and soft bounces (e.g., the user's mailbox is full), and different behavior may be performed for each type of bounce. For example, the directory system may remove the listing entirely in response to a hard bounce, and the directory system may try the listing again every few days in response to a soft bounce until a threshold is reached before removing the listing. If no bounce message is received, then the directory system adds points to the listing. If no bounce message is received, and the directory system receives an indication that the message was read, then more points are added to the listing. The test email message may request a read receipt or may contain a tracking pixel that the recipient's email reader loads when the recipient reads the message that allows the directory system to determine when the message is read.

In some embodiments, the directory system decays the points assigned to each listing over time. For example, the directory system may send a test email message in accordance with the process described above and assign 20 points to a listing, and then deduct one point every month for six months thereafter. After six months, the directory system may send another test email message, and if the email address is still valid, the directory system may add additional points to the listing. Thus, points decay over time but are refreshed if the listing is still valid. When decaying points, the directory system may prevent the number of points from going to zero such that any listing that was known to be valid at one time will have at least one point until it is known to be invalid (e.g., by receiving a bounce message).

In some embodiments, the directory system determines whether to include a listing in searches based on the number of points assigned to the listing. For example, the directory system may require that the listing meet a certain threshold (e.g., five points) before displaying the listing in response to a search. This prevents low quality listings from being displayed to a searching user.

### CONCLUSION

From the foregoing, it will be appreciated that specific embodiments of the directory system have been described herein for purposes of illustration, but that various modifications may be made without deviating from the spirit and scope of the invention. For example, although email has been described as one alternative to the telephone for contacting a user, other alternatives exist and may be created in the future that work equally well with the directory system. Accordingly, the invention is not limited except as by the appended claims.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled,” as generally used herein, refers to two or more elements that may be either directly connected, or connected by way of one or more intermediate elements. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. In addition, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

These and other changes can be made to the invention in light of the above Detailed Description. While the above description details certain embodiments of the invention and describes the best mode contemplated, no matter how detailed the above appears in text, the invention can be practiced in many ways. Details of the system may vary considerably in implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I/We claim:

1. A method in a computer system for identifying directory listings of multiple types, the method comprising:
receiving from a searching user a search request containing input information for identifying a target individual;
searching listings from multiple aggregated sources of data that may contain information about the individual to identify listings that match the received input information to create search results;
merging listings containing similar listing information to reduce a number of listings in the search results; and
displaying the merged listings to the searching user.

2. The method of claim 1 wherein merging listings comprises identifying a listing having a lowest cost when multiple similar listings are identified.

3. The method of claim 1 wherein merging listings comprises identifying listings containing the same name.

4. The method of claim 1 wherein merging listings comprises identifying similar information based on fuzzy matching.

5. The method of claim 1 wherein merging listings comprises identifying multiple email addresses for the target individual and displaying a single email address indication to the searching user.

6. The method of claim 1 wherein merging listings is performed dynamically after a search request is received.

7. The method of claim 1 including charging the searching user for sending email to the target individual, wherein an amount charged is the same regardless of the number of email addresses identified in the matching listings.

8. The method of claim 1 including charging the searching user for sending email to the target individual.

9. The method of claim 1 wherein the displayed listings contain a link for sending email to the target individual through an email relay that hides the target individual's email address from the searching user.

10. A computer system for displaying directory listings of multiple types to a searching user, comprising:
a receive query component configured to receive a search request containing input information for identifying a target entity;
a search component configured to search listings from multiple aggregated sources of data that may contain information about the individual to identify listings that match the received input information and to create search results;
a merge listings component configured to merge listings containing similar listing information to reduce the number of listings in the search results; and
a display listings component configured to display the merged listings to the searching user.

11. The system of claim 10 wherein the search component searches listings associated with multiple data providers.

12. The system of claim 10 wherein the display listings component is further configured to hide at least some information contained in each listing to protect the target entity's privacy.

13. The system of claim 10 wherein the display listings component is further configured to retrieve and display additional information for each listing based on the geographic information contained in the listing.

14. A computer-readable medium encoded with instructions for controlling a computer system to maintain a directory of email listings, by a method comprising:
harvesting email address from one or more data sources to create directory listings;
for each directory listing:
sending an email message to an email address for a person associated with a directory listing; and
assigning quality points to the directory listing based on business rules that provide an indication of the estimated reliability of the email address, wherein a higher number of points indicates a listing with an email address that is more likely to be valid than a listing with a lower number of points.

15. The computer-readable medium of claim 15 wherein the method further comprises periodically deducting quality points from the listing.

16. The computer-readable medium of claim 14 wherein the email message contains tracking information for determining if the person opened the email message, and wherein points are added to the listing if the email message was opened.

17. The computer-readable medium of claim 14 wherein assigning quality points comprises determining a domain of the email address associated with each directory listing.

18. The computer-readable medium of claim 14 including when a bounce message is received in response to the email message, removing the listing from the directory of listings.

19. The computer-readable medium of claim 14 including determining whether to include the directory listing in response to a search for directory listings based on quality points assigned to the listing.

20. The computer-readable medium of claim 14 including periodically sending another email message to the email address to refresh the quality points associated with the listing.
